(19) United States
(12) Patent Application Publication
(10) Pub. No.: US 2018/0372875 A1
(43) Pub. Date: Dec. 27, 2018

(54) SENSOR CONFIGURATION FOR AN AUTONOMOUS SEMI-TRUCK

(71) Applicant: Uber Technologies, Inc., San Francisco, CA (US)

(72) Inventors: Soren Juelsgaard, San Francisco, CA (US); Michael Carter, San Francisco, CA (US)

(21) Appl. No.: 16/010,281

(22) Filed: Jun. 15, 2018

Related U.S. Application Data
(60) Provisional application No. 62/525,192, filed on Jun. 27, 2017.

(51) Int. Cl. G01S 17/93; G05D 1/00; G01S 17/87; G01S 13/86

(52) U.S. Cl. CPC G01S 17/936; G05D 1/0088; G01S 7/4813; G01S 13/865; G05D 2201/0213; G01S 17/87

(57) ABSTRACT

An autonomous semi-truck can include a cabin, a drive system operable to drive the autonomous semi-truck, and a configuration of sensors mounted to the cabin. The configuration of sensors can include at least one high-definition LIDAR sensor having a first field of view that encompasses a region in front of the autonomous semi-truck, and a set of sensors having fields of view that encompass side regions extending laterally from each side of a trailer coupled to the autonomous semi-truck. The autonomous semi-truck can further include a control system that receives sensor data from the at least one HD LIDAR sensor and the set of sensors and autonomously operates the drive system based on the received sensor data.

### CROSS REFERENCE TO RELATED APPLICATIONS

This application claims the benefit of priority to U.S. Provisional Application No. 62/525,192, entitled “Sensor Configuration for Providing Field of View for Autonomously Operating Semi-Trucks,” filed on Jun. 27, 2017; the aforementioned application being hereby incorporated by reference in its entirety.

### BACKGROUND

Semi-trucks (“trucks”) refer to a type of freight vehicle, having a front vehicle (sometimes referred to a “tractor” or “tractor truck”) that can attach and transport a trailer (a “semi-trailer” or “cargo trailer”). Semi-trucks, in general, pose numerous challenges with respect to how they are driven, given the size, geometry and weight. For this reason, truck drivers are often required to have separate credentials in order to operate a semi-truck.

### BRIEF DESCRIPTION OF THE DRAWINGS

FIG. 1 is a block diagram illustrating an example autonomous truck implementing a control system, according to various embodiments;

FIG. 2 illustrates a computing system upon which an autonomous control system of an autonomous semi-truck may be implemented, according to one or more embodiments;

FIG. 3A shows an example HD LIDAR module, according to example implementations;

FIG. 3B shows an example assembly, according to one or more embodiments;

FIG. 4 illustrates fields of view for an autonomous truck using an example sensor configuration, as described with various examples;

FIGS. 5A and 5B illustrate an example semi-truck that includes a single high definition (HD) LIDAR sensor, according to one or more embodiments;

FIG. 6A and FIG. 6B illustrate variations in which an example autonomous semi-truck is deployed with two HD LIDAR sensors, according to one or more embodiments;

FIG. 7A and FIG. 7B illustrate variations in which an example semi-truck is deployed with three HD LIDAR sensors, according to one or more embodiments; and

FIGS. 8A through 8C illustrate an autonomous truck with sensor configurations as described herein.

### DETAILED DESCRIPTION

Autonomous vehicle control (including fully and partially autonomous vehicle control) requires a sensor view of the vehicle's surroundings so that an on-board autonomous control system can perform object detection, tracking, and motion planning operations. Semi-trucks include a tractor with a cabin and a fifth wheel upon which the kingpin of a trailer is coupled for articulated coupling. Due to the dimensions, configuration, and articulation of the semi-trailer truck, significant blind spots exist for human drivers. These blind spots are mitigated through the use of large mirrors, and more recently, blind spot cameras. One advantage, among others, of a number example autonomous systems described herein is the placement of a number of sensors, including different sensors types, to create a fully or near-fully encompassed sensor view of the truck's surrounding environment.

Examples described herein include a truck type vehicle having a tractor portion and an articulated coupling portion (e.g., a fifth wheel), referred herein as a “semi-truck”, that can be autonomously driven while attached to a trailer via the coupling portion. In some examples, a semi-truck is provided having a configuration of sensors to acquire a fused sensor view for enabling autonomous operation of the semi-truck. In particular, examples provide for a semi-truck to include a configuration of sensors that enables the truck to autonomously operate to respond to obstacles on the roadway, change lanes in light or medium traffic, merge onto highways, and exit off of highways. Such sensors can comprise a set of LIDAR sensors, cameras, radar sensors, sonar sensors, and the like. In various examples, reference is made to a “high definition” (HD) LIDAR sensor versus a “low definition” (LD) LIDAR sensor. As used herein, HD is a defined term referring to LIDAR sensors having more than a threshold number of laser channels (e.g. about thirty-two channels), such as a sixty-four channel LIDAR sensor (e.g., an HDL-64 LIDAR sensor manufactured by VELODYNE LIDAR). LD refers to LIDAR sensors having less than a threshold number of laser channels, (e.g., about thirty-two channels), such as a sixteen channel PUCK™ LIDAR sensor manufactured by VELODYNE LIDAR.

The autonomous semi-truck can include a cabin, a drive system (e.g., comprising acceleration, braking, and steering mechanisms), a configuration of sensors, and an autonomous control system that receives sensor inputs from each sensor of the configuration, and provides control inputs to the drive system to autonomously operate the vehicle. The configuration of sensors can include a first set of sensors that include a field of view that encompasses a region in front of the vehicle, and a second set of sensors having a field of view that encompasses the side regions extending laterally from each side of the tractor truck. As described herein, the side regions can extend rearward to substantially include the full length of an attached trailer.

It will be appreciated that the field of view of a sensor need not be the instantaneous field of view of the sensor. For example, a scanning sensor, such as a rotating LIDAR sensor may have a narrow horizontal FOV at any one given time, however due to the rotating scanning of the LIDAR sensor, the total field of view of the sensor is the combined field of view over a complete revolution of the LIDAR unit.

In various examples, the configuration of sensors can include one or more sensor assemblies mounted to an exterior side of the vehicle (e.g., replacing one or more side-mirrors of the tractor), and/or a region that is next to or under a side mirror of the truck. The sensor assemblies can comprise one or more LD LIDAR scanners, radar detectors, sonar sensors, cameras, and/or at least one HD LIDAR sensor mounted to a cabin roof of the semi-truck. In certain variations, the sensor configuration can include multiple HD LIDAR sensors in a certain arrangement, such as a pair of HD LIDAR sensors mounted on opposite sides of the cabin roof of the truck. In variations, the sensor configuration can include two HD LIDAR sensors mounted on opposite sides of the cabin (e.g., below the cabin roof), and a third HD LIDAR sensor mounted at a center position of the cabin roof.

As used herein, a computing device refers to a device corresponding to one or more computers, cellular devices or smartphones, laptop computers, tablet devices, virtual reality (VR) and/or augmented reality (AR) devices, wearable computing devices, computer stacks (e.g., comprising processors, such as a central processing unit, graphics processing unit, and/or field-programmable gate arrays (FPGAs)), etc., that can provide process input data and generate one or more control signal. In example embodiments, the computing device may provide additional functionality, such as network connectivity and processing resources for communicating over a network. A computing device can correspond to custom hardware, in-vehicle devices, or on-board computers, etc.

One or more examples described herein provide that methods, techniques, and actions performed by a computing device are performed programmatically, or as a computer-implemented method. Programmatically, as used herein, means through the execution of software, code, and/or computer-executable instructions. These instructions can be stored in one or more memory resources of the computing device. A programmatically performed step may or may not be automatic. An action being performed automatically, as used herein, means the action is performed without necessarily requiring human intervention.

One or more examples described herein can be implemented using programmatic modules, engines, or components. A programmatic module, engine, or component can include a program, a sub-routine, a portion of a program, and/or a software component and/or a hardware component capable of performing one or more stated tasks or functions. As used herein, a module or component can exist on a hardware component independently of other modules or components. Alternatively, a module or component can be a shared element or process of other modules, programs or machines.

Some examples described herein can generally require the use of computing devices, including processing and memory resources. For example, one or more examples described herein may be implemented, in whole or in part, on computing devices such as servers, desktop computers, smartphones, tablet computers, laptop computers, and/or network equipment (e.g., routers). Memory, processing, and network resources may all be used in connection with the establishment, use, or performance of any example described herein (including with the performance of any method or with the implementation of any system).

Furthermore, one or more examples described herein may be implemented through the use of instructions that are executable by one or more processors, resulting in a special-purpose computer. These instructions may be carried on a computer-readable medium. Logical machines, engines, and modules shown or described with figures below may be executed by processing resources and computer-readable mediums on which instructions for implementing examples disclosed herein can be carried and/or executed. In particular, the numerous machines shown with examples of the disclosure include processors, FPGAs, application specified integrated circuits (ASICs), and/or various forms of memory for holding data and instructions. Examples of computer-readable mediums include permanent memory storage devices, such as hard drives on personal computers or servers. Other examples of computer storage mediums include portable storage units, such as CD or DVD units, flash memory (such as those carried on smartphones, multifunctional devices or tablets), and magnetic memory. Computers, terminals, network enabled devices (e.g., mobile devices, such as cell phones) are all examples of machines and devices that utilize processors, memory, and instructions stored on computer-readable mediums. Additionally, examples may be implemented in the form of computer-programs, or a computer usable carrier medium capable of carrying such a program.

System Description

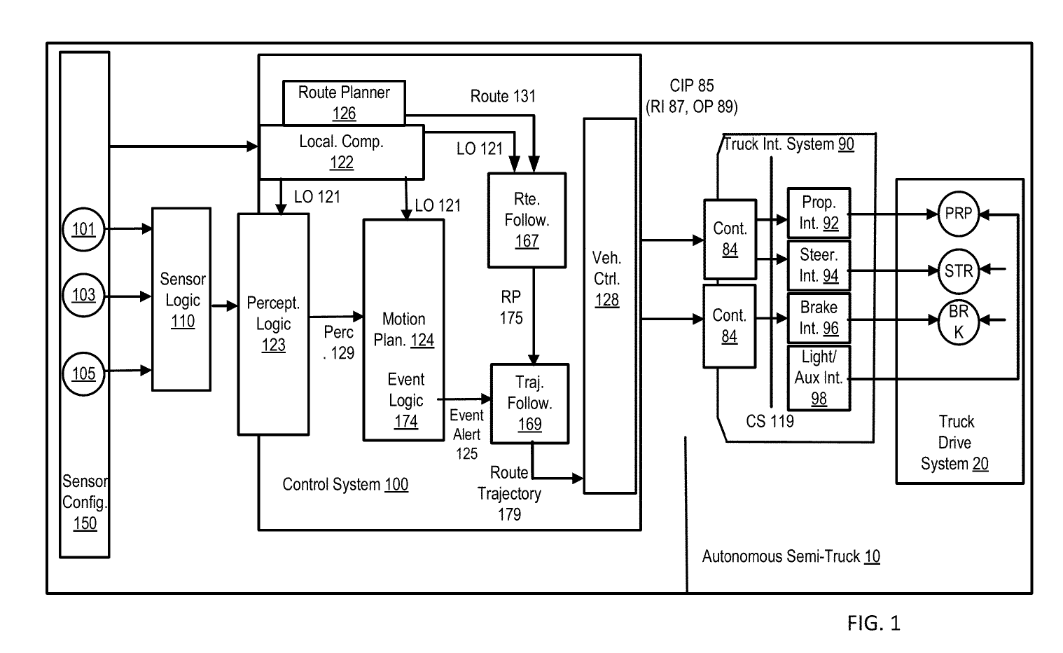

FIG. 1 illustrates an example of a control system for an autonomous truck. In an example of FIG. 1, a control system 100 is used to autonomously operate a truck 10 in a given geographic region (e.g., for freight transport). In examples described, an autonomously driven truck 10 can operate without human control. For example, an autonomously driven truck 10 can steer, accelerate, shift, brake and operate lighting components without human input or intervention. Some variations also recognize that an autonomous-capable truck 10 can be operated in either an autonomous or manual mode, thus, for example, enabling a supervisory driver to take manual control.

In one implementation, the control system 100 can utilize a configuration of sensors 150 to autonomously operate the truck 10 in most common driving situations. For example, the control system 100 can operate the truck 10 by autonomously steering, accelerating, and braking the truck 10 as the truck progresses to a destination along a selected route.

In an example of FIG. 1, the control system 100 includes a computer or processing system which operates to process sensor data that is obtained on the truck 10 with respect to a road segment on which the truck 10 is operating. The sensor data can be used to determine actions which are to be performed by the truck 10 in order for the truck 10 to continue on the selected route to a destination. In some variations, the control system 100 can include other functionality, such as wireless communication capabilities, to send and/or receive wireless communications with one or more remote sources. In controlling the truck 10, the control system 100 can issue instructions and data, shown as commands 85, which programmatically controls various electromechanical interfaces of the truck 10. The commands 85 can serve to control a truck drive system 20 of the truck 10, which can include propulsion, braking, and steering systems, as shown in FIG. 1.

The autonomous truck 10 can include a sensor configuration 150 that includes multiple types of sensors 101, 103, 105, which combine to provide a computerized perception of the space and environment surrounding the truck 10. The control system 100 can operate within the autonomous truck 10 to receive sensor data from the sensor configuration 150, and to control components of a truck's drive system 20 using one or more drive system interfaces. By way of examples, the sensors 101, 103, 105 may include one or more LIDAR sensors, radar sensors, and/or cameras.

The sensor configuration 150 can be uniquely configured based on a set of pre-conditions that maximize coverage (e.g., including typical blind spots), and addressing challenges of certain edge-cases observed during autonomous operation. Such edge-cases can include highway merging with significant speed differential compared to other vehicles, highway exiting, lane changes (e.g., in light and medium traffic), executing turns, responding to road obstacles (e.g., debris, emergency vehicles, pedestrians, etc.), and/or docking procedures. The pre-conditions for the sensor configuration 150 can require at least one active sensor (e.g., a LIDAR or radar sensor) and at least one passive sensor (e.g., a camera) to target any object within a certain proximity of the semi-truck 10 that has a trailer coupled thereto. For vehicles such as motorcycles and cars, a pre-condition of the sensor configuration 150 can require a certain number of LIDAR points that target the vehicle for adequate resolution (e.g., at least thirty LIDAR points), and/or a threshold number of pixels for adequate imaging (e.g., at least twenty-five vertical and/or horizontal pixels).

Additional pre-conditions can relate to the types of active and passive sensors, which can range from wide angle radars, long range radars, narrow field of view cameras (e.g., xenon cameras), wide angle cameras, standard vision cameras, HD LIDAR sensors (e.g., having sixty-four channels), and LD LIDAR sensors (e.g., having sixteen channels). Accordingly, maximal coverage, within practical constraints (e.g., cost and/or processing power of the control system 100), may be achieved through an optimal sensor configuration 150 utilizing these different types of sensors. Other pre-conditions can require that the positioning of the sensors does not increase the height, width, and/or length of the semi-truck 10. For example, mounted LIDAR, radar, or camera sensor should not extend beyond the width of existing mirrors of the truck 10.

In some aspects, the pre-conditions may also require triple sensor data redundancy for any particular object placed or otherwise observed around the truck 10. For example, a pedestrian located behind the trailer should be detected by at least one radar, at least one LIDAR, and at least one camera. Thus, each modality (e.g., LIDAR, radar, and camera) should have a 360-degree field of view around the truck 10 and trailer combination, which can enable the control system 100 to detect surrounding objects in variable conditions (e.g., at night or in the rain or snow). The sensor configuration 150 can further be such that all sensors are in the same reference frame in order to reduce noise in the sensor data (e.g., due to inconsistent movement and deflection). The pre-conditions for the sensor configuration 150 can also require collocation of imaging and active sensors. For example, for every mounted LIDAR, a camera must be mounted at the same location or within a threshold proximity of the LIDAR (e.g., within thirty centimeters). The reasoning for this constraint can correspond to the minimization of parallax, which would otherwise require additional processing (e.g., a coordinate transform) to resolve a detected object.

According to various examples, the sensors 101, 103, 105 of the sensor configuration 150 each have a respective field of view, and operate to collectively generate a sensor view about the truck 10 and coupled trailer. In some examples, the sensor configuration 150 can include a first set of range sensors that cover a field of view that is in front of the truck 10. Additionally, the configuration of sensors 150 can include additional sets of sensors that cover a field of view that encompasses side regions extending from the sides of the truck 10. The sensor configuration 150 may also include sensors that have fields of view that extend the full length of the coupled trailer. Still further, the sensor configuration 150 can include a field of view that includes a region directly behind the trailer of the truck 10.

The control system 100 can be implemented using a combination of processing and memory resources. In some variations, the control system 100 can include sensor logic 110 to process sensor data of specific types. The sensor logic 110 can be implemented on raw or processed sensor data. In some examples, the sensor logic 110 may be implemented by a distributed set of processing resources which process sensor information received from one or more of the sensors 101, 103, and 105 of the sensor configuration 150. For example, the control system 100 can include a dedicated processing resource, such as provided with a field programmable gate array (“FPGA”) which receives and/or processes raw image data from the camera sensor. In one example, the sensor logic 110 can fuse the sensor data generated by each of the sensors 101, 103, 105 and/or sensor types of the sensor configuration. The fused sensor view (e.g., comprising fused radar, LIDAR, and image data) can comprise a three-dimensional view of the surrounding environment of the truck 10 and coupled trailer, and can be provided to the perception logic 123 for object detection, classification, and prediction operations.

According to one implementation, the truck interface subsystem 90 can include one or more interfaces for enabling control of the truck's drive system 20. The truck interface subsystem 90 can include, for example, a propulsion interface 92 to electrically (or through programming) control a propulsion component (e.g., a gas pedal), a steering interface 94 for a steering mechanism, a braking interface 96 for a braking component, and lighting/auxiliary interface 98 for exterior lights of the truck. The truck interface subsystem 90 and/or control system 100 can include one or more controllers 84 which receive one or more commands 85 from the control system 100. The commands 85 can include trajectory input 87 (e.g., steer, propel, brake) and one or more operational parameters 89 which specify an operational state of the truck (e.g., desired speed and pose, acceleration, etc.).

In turn, the controller(s) 84 generate control signals 119 in response to receiving the commands 85 for one or more of the truck interfaces 92, 94, 96, 98. The controllers 84 use the commands 85 as input to control propulsion, steering, braking, and/or other truck behavior while the autonomous truck 10 follows a trajectory. Thus, while the truck 10 may follow a trajectory, the controller(s) 84 can continuously adjust and alter the movement of the truck 10 in response to receiving a corresponding set of commands 85 from the control system 100. Absent events or conditions which affect the confidence of the truck in safely progressing on the route, the control system 100 can generate additional commands 85 from which the controller(s) 84 can generate various truck control signals 119 for the different interfaces of the truck interface subsystem 90.

According to examples, the commands 85 can specify actions that are to be performed by the truck's drive system 20. The actions can correlate to one or multiple truck control mechanisms (e.g., steering mechanism, brakes, etc.). The commands 85 can specify the actions, along with attributes such as magnitude, duration, directionality, or other operational characteristics. By way of example, the commands 85 generated from the control system 100 can specify a relative location of a road segment which the autonomous truck 10 is to occupy while in motion (e.g., change lanes, move to center divider or towards shoulder, turn truck 10, etc.). As other examples, the commands 85 can specify a speed, a change in acceleration (or deceleration) from braking or accelerating, a turning action, or a state change of exterior lighting or other components. The controllers 84 translate the commands 85 into control signals 119 for a corresponding interface of the truck interface subsystem 90. The control signals 119 can take the form of electrical signals which correlate to the specified truck action by virtue of electrical characteristics that have attributes for magnitude, duration, frequency or pulse, or other electrical characteristics.

In an example of FIG. 1, the control system 100 includes a localization component 122, a perception component 123, a motion planning component 124, a route planner 126, and a vehicle control interface 128. The control interface 128 represents logic that communicates with the truck interface sub-system 90, in order to control the truck's drive system 20 with respect to steering, acceleration, braking, and other parameters.

In some examples, the localization component 122 processes the sensor information generated from the sensor configuration 150 to generate localization output 121, corresponding to a position of the truck 10 within a road segment. The localization output 121 can be specific in terms of identifying, for example, any one or more of a driving lane that the truck 10 is using, the truck's distance from an edge of the road, the truck's distance from the edge of the driving lane, and/or a distance of travel from a point of reference identified in a particular submap. In some examples, the localization output 121 can determine the relative location of the truck 10 within a road segment to within less than a foot, or to less than a half foot.

The sensor configuration 150 may generate sensor information for the control system 100. As described herein, the sensor configuration 150 can provide sensor data that comprises a fused sensor view of the surrounding environment of the truck 10. In doing so, for any given object, the sensor configuration 150 can provide double or triple redundancy of the detected object using a combination of LIDAR data, radar data, and image data. In variations, infrared (IR) sensor data and/or sonar sensor data from IR and/or sonar sensors indicating the detected object may also be provided to the control system 100. In further variations, the sensor configuration 150 can comprise multiple HD LIDAR sensors, and a relaxation of double or triple modality constraints. For example, the truck 10 and/or coupled trailer can include two or more HD LIDAR sensors (e.g., sixty-four channel LIDAR modules) that enable the control system 100 to classify objects without redundant radar or image data.

In various examples, for any external object of interest (e.g., a pedestrian, other vehicle, or obstacle), the sensor data generated by the sensor configuration 150 can comprise a point cloud identifying the object from a LIDAR sensor, a radar reading of the object from a radar sensor, and image data indicating the object from a camera. The sensor configuration 150 can provide a maximal sensor view of the surrounding environment of the truck 10 and coupled trailer in accordance with the pre-conditions and constraints described herein.

The perception logic 123 may process the fused sensor view to identify moving objects in the surrounding environment of the truck 10. The perception logic 123 may generate a perception output 129 that identifies information about moving objects, such as a classification of the object. The perception logic 123 may, for example, subtract objects which are deemed to be static and persistent from the current sensor state of the truck. In this way, the perception logic 123 may, for example, generate perception output 129 that is based on the fused sensor data, but processed to exclude static objects. The perception output 129 can identify each of the classified objects of interest from the fused sensor view, such as dynamic objects in the environment, state information associated with individual objects (e.g., whether object is moving, pose of object, direction of object), and/or a predicted trajectory of each dynamic object.

The perception output 129 can be processed by the motion planning component 124. When dynamic objects are detected, the motion planning component 124 can generate an event alert 125 that causes the trajectory following component 169 to determine a route trajectory 179 for the truck 10 to avoid a collision with the dynamic object. The route trajectory 179 can be used by the vehicle control interface 128 in advancing the truck 10 forward along a current route 131.

In certain implementations, the motion planning component 124 may include event logic 174 to detect avoidance events (e.g., a collision event) and to trigger a response to a detected event. An avoidance event can correspond to a roadway condition or obstacle which poses a potential threat of collision to the truck 10. By way of example, an avoidance event can include an object in the road segment, heavy traffic in front of the truck 10, and/or moisture or other environmental conditions on the road segment. The event logic 174 can implement sensor processing logic to detect the presence of objects or road conditions which may impact stable control of the truck 10. For example, the event logic 174 may process the objects of interest in front of the truck 10 (e.g., a cinderblock in roadway), objects of interest to the side of the truck (e.g., a small vehicle, motorcycle, or bicyclist), and objects of interest approaching the truck 10 from the rear (e.g., a fast-moving vehicle). Additionally, the event logic 174 can also detect potholes and roadway debris, and cause a trajectory following component 169 to generate route trajectories 179 accordingly.

In some examples, when events are detected, the event logic 174 can signal an event alert 125 that classifies the event. The event alert 125 may also indicate the type of avoidance action which may be performed. For example, an event can be scored or classified between a range of likely harmlessness (e.g., small debris in roadway) to very harmful (e.g., a stalled vehicle immediately ahead of the truck 10). In turn, the trajectory following component 169 can adjust the route trajectory 179 of the truck to avoid or accommodate the event.

When a dynamic object of a particular class moves into a position of likely collision or interference, some examples provide that event logic 174 can cause the truck control interface 128 to generate commands 85 that correspond to an event avoidance action. For example, in the event that a vehicle moves into the path of the truck 10, event logic 174 can signal an alert 125 to avoid an imminent collision. The alert 125 may indicate (i) a classification of the event (e.g., “serious” and/or “immediate”), (ii) information about the event, such as the type of object that caused the alert 125, and/or information indicating a type of action the truck 10 should take (e.g., location of the object relative to a path of the truck 10, a size or type of object, and the like).

The route planner 126 can determine a high-level route 131 for the truck 10 to use on a given trip to a destination. In determining the route 131, the route planner 126 can utilize a map database, such as provided over a network through a map service. Based on a given destination and current location (e.g., as provided through a satellite positioning system), the route planner 126 can select one or more route segments that collectively form a route 131 for the autonomous truck 10 to advance towards each selected destination.

The truck control interface 128 can include a route following component 167 and a trajectory following component 169. The route following component 167 can receive the route 131 from the route planner 126. Based at least in part on the route 131, the route following component 167 can output a high-level route plan 175 for the autonomous truck 10 (e.g., indicating upcoming road segments and turns). The trajectory following component 169 can receive the route plan 175, as well as event alerts 125 from the motion planner 124 (or event logic 174). The trajectory following component 169 can determine a low-level route trajectory 179 to be immediately executed by the truck 10. Alternatively, the trajectory following component 169 can determine the route trajectory 179 by adjusting the route plan 175 based on the event alerts 125 (e.g., swerve to avoid collision) and/or by using the motion plan 179 without the event alerts 125 (e.g., when collision probability is low or zero). In this way, the truck's drive system 20 can be operated to make adjustments to an immediate route plan 175 based on real-time conditions detected on the roadway.

The truck control interface 128 can generate commands 85 as output to control components of the truck 10 in order to implement the truck trajectory 179. The commands can further implement driving rules and actions based on various context and inputs. Such commands 85 can be based on an HD point cloud map of the surrounding environment of truck 10 and generated by a number of HD LIDAR sensors arranged to have maximal coverage of the surrounding environment. The use of HD LIDAR sensors enables detailed and long range detection of objects to improve edge-cases of autonomous driving (e.g., merging onto freeways, lane changing, exiting freeways, and performing sharp turns). The use of such HD LIDAR sensors in predetermined mounting locations on the autonomous truck 10 and/or trailer can allow for less radar and camera sensors due to the high quality of the point cloud map and certainty in detecting and classifying object using only the HD point cloud. Discussed below are example arrangements of HD LIDAR sensors mounted at strategic locations on the truck 10 and/or trailer to provide ample coverage of the truck's surroundings.

Computer System

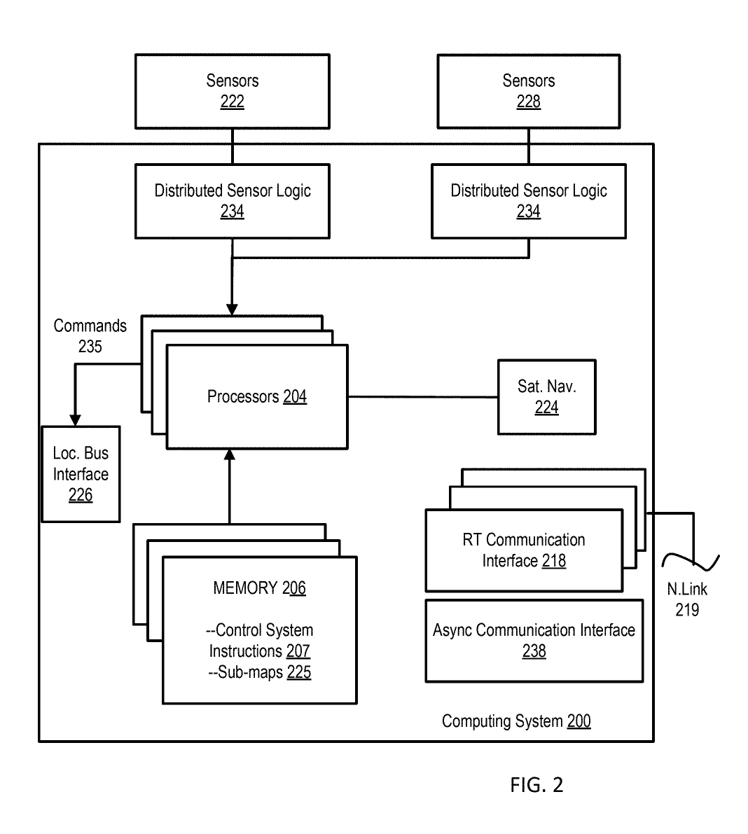

FIG. 2 is a block diagram of a computing system 200 upon which an autonomous control system may be implemented. According to some examples, the computing system 200 can be implemented using a set of processors 204, memory resources 206, multiple sensors interfaces 222, 228 (or interfaces for sensors) and location-aware hardware, such as shown by satellite navigation component 224 (e.g., a Global Positioning System (GPS) receiver). In an example shown, the computing system 200 can be distributed spatially into various regions of the truck 10. For example, a processor bank 204 with accompanying memory resources 206 can be provided in a cabin portion of the truck 10. The various processing resources 204 of the computing system 200 can also include distributed sensor logic 234, which can be implemented using microprocessors or integrated circuits. In some examples, the distributed sensor logic 234 can be implemented using FPGAs.

In an example of FIG. 2, the computing system 200 further includes multiple communication interfaces, including a real-time communication interface 218 and an asynchronous communication interface 238. The various communication interfaces 218, 238 can send and receive communications to other vehicles, central servers or datacenters, human assistance operators, or other remote entities. For example, a centralized coordination system for freight transport services can communicate with the computing system 200 via the real-time communication interface 218 or asynchronous communication interface 238 to provide sequential cargo pick-up and drop-off locations, trailer coupling and decoupling locations, fuel or charging stations, and/or parking locations.

The computing system 200 can also include a local communication interface 226 (or series of local links) to vehicle interfaces and other resources of the truck 10. In one implementation, the local communication interface 226 provides a data bus or other local link to electro-mechanical interfaces of the truck 10, such as used to operate steering, acceleration, and braking systems, as well as to data resources of the truck 10 (e.g., vehicle processor, OBD memory, etc.). The local communication interface 226 may be used to signal commands 235 to the electro-mechanical interfaces in order to autonomously operate the truck 10.

The memory resources 206 can include, for example, main memory, a read-only memory (ROM), storage device, and cache resources. The main memory of memory resources 206 can include random access memory (RAM) or other dynamic storage device, for storing information and instructions which are executable by the processors 204. The information and instructions may enable the processor(s) 204 to interpret and respond to objects detected in the fused sensor view of the sensor configuration 150.

The processors 204 can execute instructions for processing information stored with the main memory of the memory resources 206. The main memory can also store temporary variables or other intermediate information which can be used during execution of instructions by one or more of the processors 204. The memory resources 206 can also include ROM or other static storage device for storing static information and instructions for one or more of the processors 204. The memory resources 206 can also include other forms of memory devices and components, such as a magnetic disk or optical disk, for purpose of storing information and instructions for use by one or more of the processors 204.

One or more of the communication interfaces 218, 238 can enable the autonomous truck 10 to communicate with one or more networks (e.g., cellular network) through use of a network link 219, which can be wireless or wired. The truck vehicle system 200 can establish and use multiple network links 219 at the same time. Using the network link 219, the computing system 200 can communicate with one or more remote entities, such as with other trucks, carriers, or a central freight coordination system. According to some examples, the computing system 200 stores instructions 207 for processing sensor information received from multiple types of sensors 222, 228, as described with various examples.

In operating the autonomous truck 10, the one or more processors 204 can execute control system instructions 207 to autonomously perform perception, prediction, motion planning, and trajectory execution operations. Among other control operations, the one or more processors 204 may access data from a set of stored sub-maps 225 in order to determine a route, an immediate path forward, and information about a road segment that is to be traversed by the truck 10. The sub-maps 225 can be stored in the memory 206 of the truck and/or received responsively from an external source using one of the communication interfaces 218, 238. For example, the memory 206 can store a database of roadway information for future use, and the asynchronous communication interface 238 can repeatedly receive data to update the database (e.g., after another vehicle does a run through a road segment).

High-Definition Lidar Sensor

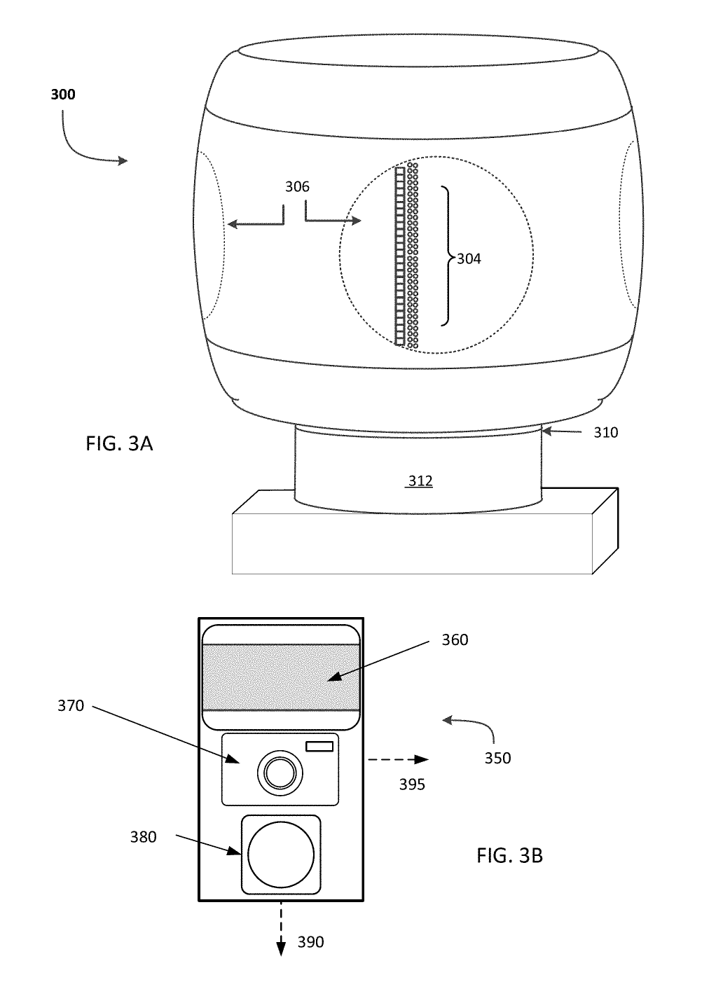

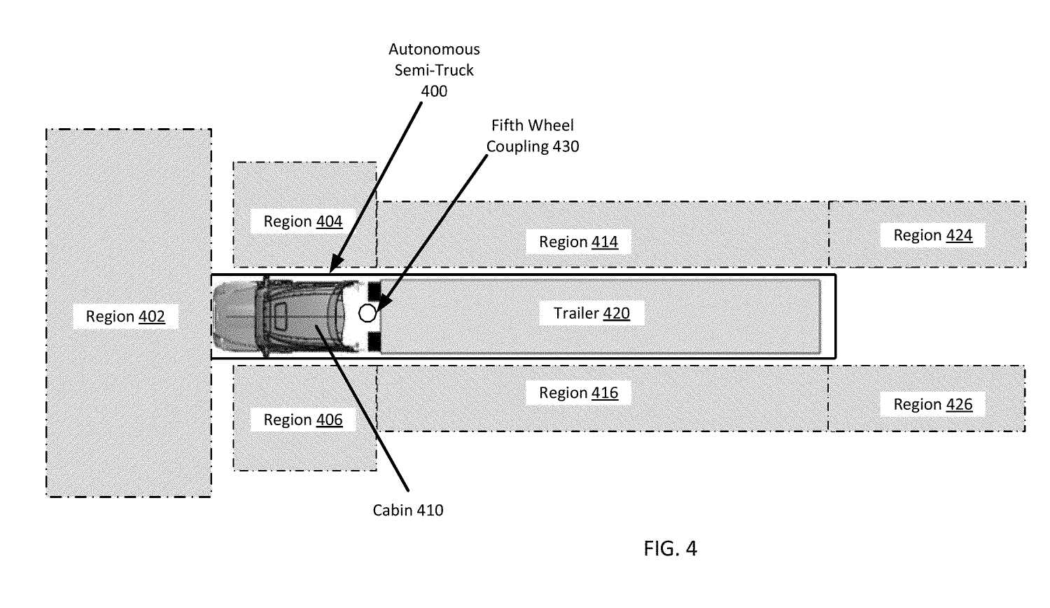

FIG. 3A shows an example HD LIDAR sensor 300, according to example implementations. Referring to FIG. 3A, the HD LIDAR sensor 300 can include a housing in which a multi-channel laser array 304 is housed (e.g., a sixty-four-channel laser scanner array). The laser pulses of the HD LIDAR sensor 300 can be outputted through one or more view panes 306 of the LIDAR sensor 300. In some examples, the multi-channel laser array 304 can be arranged to output laser pulses through multiple view panes around the circumference of the housing. For example, the HD LIDAR sensor 300 can include circuitry such that laser pulses from laser scanner arrays 304 are outputted through two view panes 306 of the LIDAR sensor 300 (e.g., with 180° difference in azimuthal orientation), or four view panes 306 of the LIDAR sensor 300 (e.g., with 90° difference in azimuthal orientation). In examples shown, each laser scanner array 304 can produce on the order of, for example, millions or tens of millions of points per second (PPS).

The housing of the HD LIDAR sensor 300 can be mounted or seated on a swivel bearing 310, which can enable the housing to rotate. The swivel bearing 310 can be driven by a rotary motor mounted within a rotary motor housing 312 of the LIDAR sensor 300. The rotary motor can turn the housing at any suitable rotation rate, such as 150 to 2000 revolutions per minute.

In some aspects, the HD LIDAR sensor 300 can also be mounted to an actuatable motor (e.g., a pivot motor) that causes the HD LIDAR sensor 300 to change from a vertical orientation to an angled orientation. For example, a sensor configuration in which the HD LIDAR sensor 300 is mounted to a corner or side component of the truck 100 can include a pivot motor that causes an angular displacement of the HD LIDAR sensor 300 to change and/or increase an open field of view (e.g., at low speeds or when performing certain maneuvers, such as lane changes or merging maneuvers). According to such examples, the HD LIDAR sensor 300 may be mounted to a single or multiple axis joint powered by a pivot motor to selectively pivot the HD LIDAR sensor 300 laterally. In variations, the HD LIDAR sensor 300 may be mounted on a curved rail that enables the control system 100 to selectively configure a position or angular displacement of the HD LIDAR sensor 300 as needed (e.g., prior to and during a lane change maneuver).

LIDAR data from the laser scanner array(s) 304 can be transmitted via a data bus to a control system 100 of the autonomous truck 10. The LIDAR data can comprise a fine grained three-dimensional point cloud map of the surroundings of the HD LIDAR sensor 300. Due to the dimensions of the autonomous truck 10, a primary HD LIDAR sensor 300 may be mounted to generate a dynamic point cloud of a forward operational direction of the autonomous truck 10. Additionally or alternatively, additional HD LIDAR sensors 300 may be mounted at various advantageous locations of the autonomous truck 10 to provide optimal coverage of the surrounding environment of the truck 10 and coupled trailer, as described below. In variations, one of more HD LIDAR sensors 300 may be mounted in combination with a collocated camera and/or radar sensor, or in combination with additional sensor combinations mounted elsewhere on the truck 10 for additional field of view coverage.

Sensor Assembly

FIG. 3B shows an example sensor assembly 350, according to one or more embodiments. The sensor assembly 350 can include an LD LIDAR sensor 360 (e.g., a sixteen-channel PUCK™ LIDAR), a camera 370 (e.g., having a fisheye lens, or comprising a stereoscopic pair of cameras), and/or a radar sensor 380. In variations, the sensor assembly 350 can include additional sensors, such as an IR proximity sensor or a sonar sensor. As described herein, the sensor assembly 350 can be mounted to or otherwise integrated with a side component of the autonomous truck 10, such as the rearview mirrors extending from the doors of the truck 10. In variations, the sensor assembly 350 can be mounted to or integrated with a forward rearview mirror extending from the hood of the truck 10. In further variations, the sensor assembly 350 can be mounted to replace the side mirrors of the truck 10.

The sensor assembly 350 can generate multi-modal sensor data corresponding to a field of view that would otherwise comprise a blind spot for one or more HD LIDAR sensors mounted to the truck 10 (e.g., down the sides of the truck 10). The multi-modal sensor data from the sensor assembly 350 can be provided to a control system 100 of the truck 10 to enable object detection, classification, and tracking operations (e.g., for lane changes, merging, and turning). In some aspects, the sensor assembly 350 can be selectively activated based on an imminent maneuver to be performed by the truck 10 (e.g., a lane change or merge).

It is contemplated that the use of a multi-modal sensor assembly 350 provides a fused sensor view for data redundancy in which the advantages of each sensor may be leveraged in varying weather conditions or detection conditions. For example, the radar sensor 380 advantageously detects velocity differentials, such as upcoming vehicles in an adjacent lane, whereas the LD LIDAR sensor 360 performs advantageously for object detection and distance measurements. In some aspects, multiple types of radar sensors 380 may be deployed on the sensor assembly 350 to facilitate filtering noise, including noise which may generate from the trailer. In certain implementations, the sensor assembly 350 may include only radar sensors 380. For example, multiple types of radar sensors 380 may be used to filter out radar noise signals which may be generated from the trailer. Examples recognize that radar is well-suited for detecting objects to the side and rear of the vehicle, as static objects are not usually noteworthy to the vehicle from that perspective.

Due to the relatively coarse granularity of the point cloud map of the LD LIDAR sensor 360, object classification may pose more of a challenge for the control system 100. Furthermore, LIDAR performs relatively poorly in variable conditions, such as in rain or snow. Accordingly, image data from the camera 370 can be analyzed to perform object detection and classification as needed.

In some variations, for lane changes and merging actions, the control system 100 can analyze the multi-modal sensor data in concert or hierarchically. For example, the radar data may be analyzed to detect a velocity of an upcoming vehicle, whereas the LIDAR data and/or image data can be analyzed for object classification and tracking. It is contemplated that any combination of sensors may be included in the sensor assembly 350, and may be mounted separately to the truck 10, or in concert (e.g., mounted to a common frame). It is further contemplated that a sensor assembly 350 may be collocated with an HD LIDAR sensor 300 for increased robustness.

In certain examples, the sensor assembly 350 may be mounted on a pivot axis and linear motor that enables the control system 100 to pivot the entire sensor assembly 350, or one or more sensors of the sensor assembly 350 selectively. For example, the camera 370 may be installed to pivot within the sensor assembly 350. In some implementations, the sensor assembly 350 can be pivoted about a horizontal axis 395 using a pivot motor, and/or about a vertical axis 390 using a pivot motor. The control system 100 can selectively engage the pivot motor to pivot the sensor assembly 350 or individual sensors of the sensor assembly 350 as needed (e.g., to track a passing vehicle).

Semi-Truck Fields of View

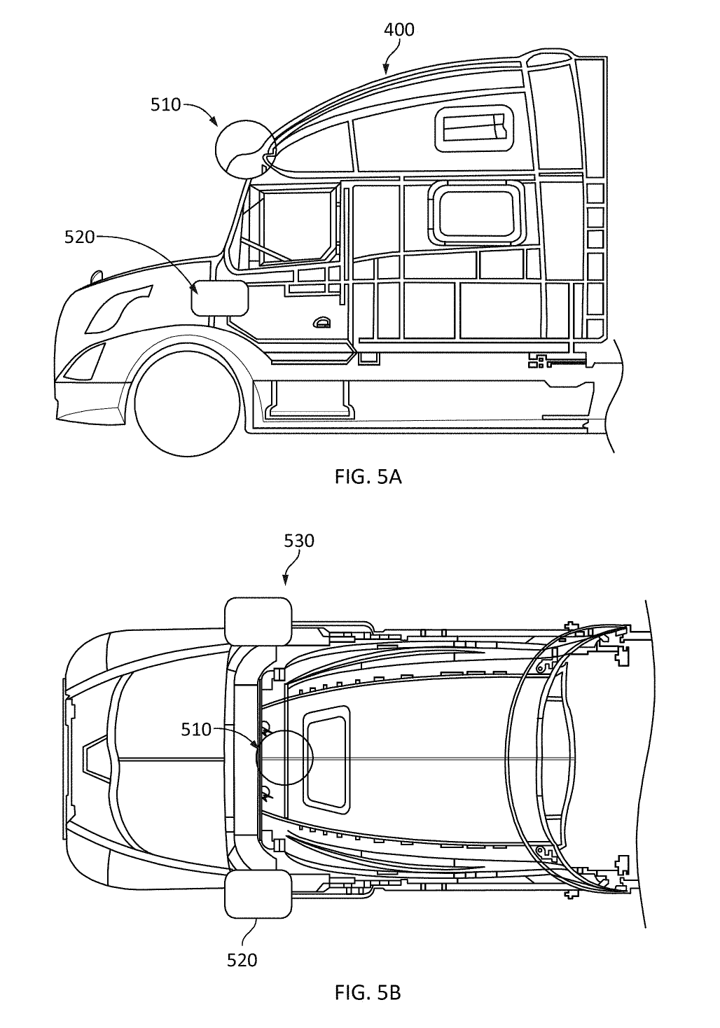

FIG. 4 illustrates fields of view for an autonomous truck using an example sensor configuration, as described with various examples. In the below description of FIG. 4, the autonomous semi-truck 400 can include a computing system 200, and can correspond to the autonomous truck 10 implementing a control system 100, as shown and described with respect to FIGS. 1 and 2. Referring to FIG. 4, the autonomous semi-truck 400 can include a cabin 410, a fifth wheel coupling 430, and a trailer 420 with a kingpin mounted to the fifth wheel coupling 430. In examples, the truck 400 includes a sensor configuration (such as the sensor configuration 150 of FIG. 1) that accommodates multiple regions about each of the cabin 410 and the trailer 420. As described with various examples, the autonomous semi-truck 400 may include one or more active range sensors (e.g., LIDAR, sonar, and/or radar sensors) having a field-of view that encompasses a forward region 402. Additionally, other sensors can be used that have fields of view that encompass side regions 404, 406, extending from lateral sides of the cabin 410. Additionally, the trailer side regions 414, 416 may be accommodated by sensors provided with the cabin 410. The field of view may also extend to regions 424, 426 that are behind the trailer 420. By mounting sensors to the cabin 410, the truck 400 can be more versatile in use, in that it can pull trailers without restrictions, such as the need for such trailers to carry sophisticated sensor equipment.

By way of example, the active range sensors may include one or more LIDAR sensors (e.g., HD LIDAR sensors under tradename HDL-64 or LD LIDAR sensors under the tradename VLP-16, each manufactured by VELODYNE LIDAR). In one example, the active range sensors may include one or HD LIDAR sensors (HDL-64s). However, since such HD LIDAR sensors are typically expensive and require more frequent calibration than lower resolution LIDAR sensors (e.g., VLP-16s), the number of HD LIDAR sensors which can be deployed on the truck 400 may be limited.

Sensor Configurations

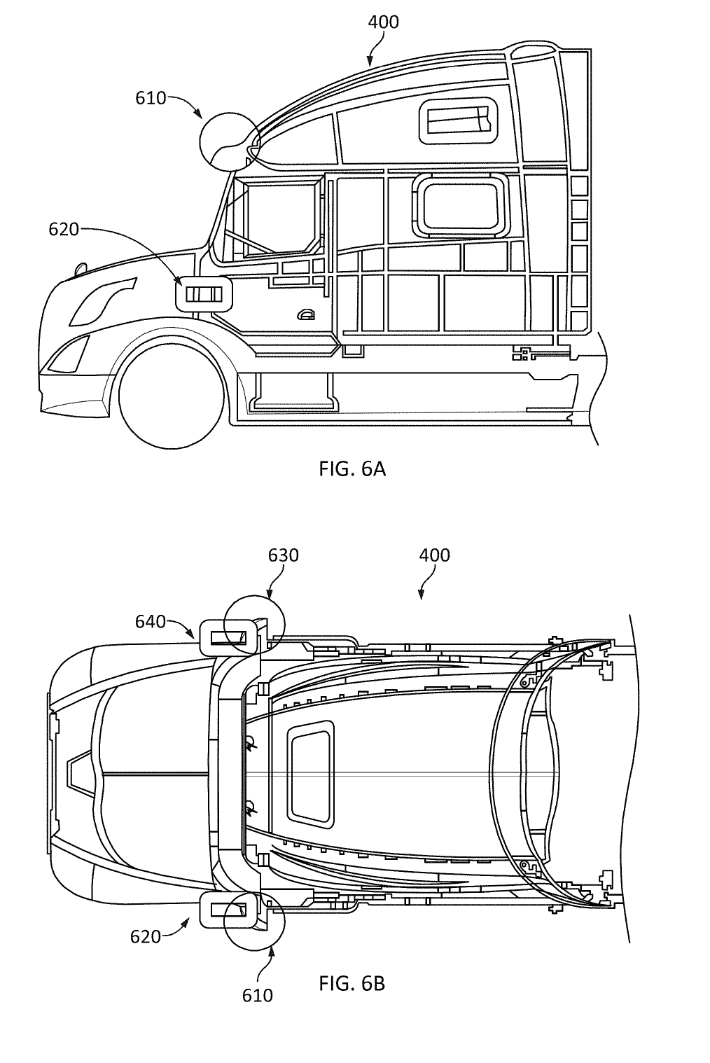

FIGS. 5A and 5B illustrate an example semi-truck having a sensor configuration that includes a single high definition (HD) LIDAR sensor, according to one or more embodiments. In the example sensor configuration shown, FIG. 5A illustrates a left-side view of an autonomous truck 400, and FIG. 5B illustrates a top-down view of the autonomous truck 400. The HD LIDAR sensor may be mounted to a center location 510 on the roof of the truck 400, and oriented to obtain a field of view that is in front of the truck 400 (e.g., extending forward from region 402 shown in FIG. 4). In certain implementations, the upper central location 510 can further include one or more cameras and/or radar sensors installed thereon, also having fields of view corresponding to region 402. In an example of FIG. 5A, other types of sensors may be used to obtain fields of view occupying the side regions 404, 406, 414, 416, 424, and 426 of FIG. 4.

According to certain examples, the positions 520 and 530 can be mounted with a pair of LD LIDAR sensors having respective fields of view that encompass regions 404, 406, 414, 424, and 426. The inclusion LD LIDAR sensors can provide valuable data for determining whether an object is present in any of regions 404, 406, 414, 424, and 426. The data generated by the LD LIDAR sensors may be supplemented with additional sensors, such as radar sensors, sonar sensors, and/or camera sensors that have at least partially overlapping field of views to provide a fused sensor view of the regions 404, 406, 414, 424, and 426 for object classification and tracking.

Accordingly, each of positions 520 and 530 may include a collocated LD LIDAR sensor and camera combination. In variations, each of positions 520 and 530 can include a collocated LD LIDAR sensor, camera, and radar sensor combination, such as the sensor assembly 350 shown and described with respect to FIG. 3B. The sensor combinations can generate dual or triple-modality sensor data for regions 404, 406, 414, 424, and 426, which the control system 100 of the truck 400 can process to detect objects (e.g., other vehicles), and classify and track the detected objects. For example, the sensor data generated by each sensor combination mounted at locations 520 and 530 can comprise image data from a camera, radar data from a radar sensor, and/or LD LIDAR data from an LD LIDAR sensor.

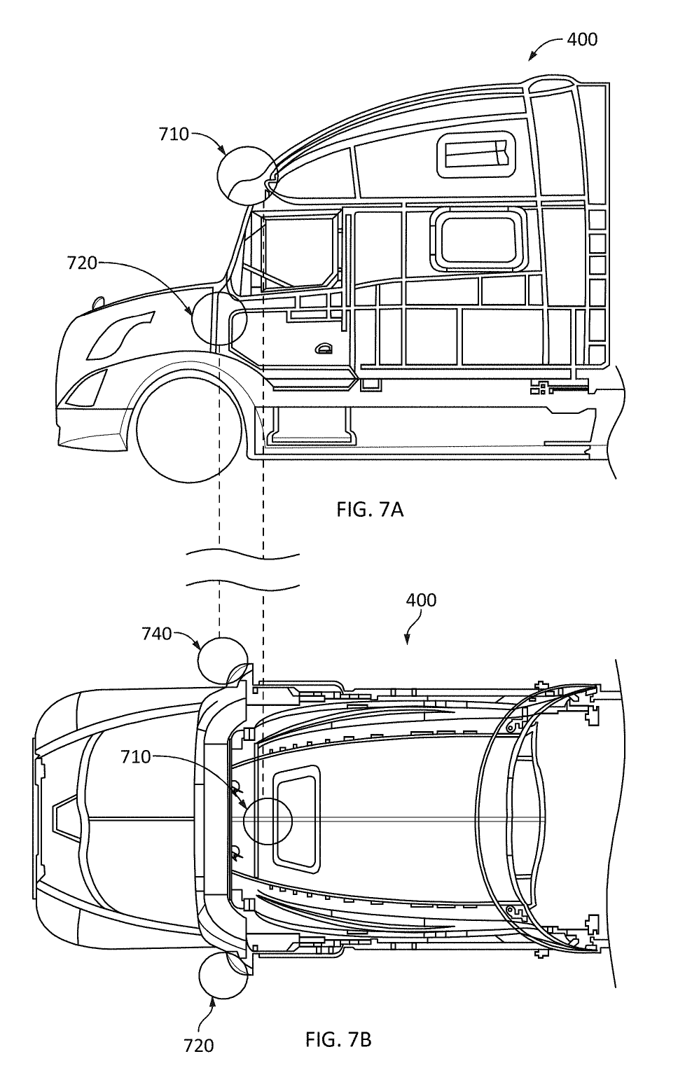

FIGS. 6A and FIG. 6B illustrate variations in which an example autonomous semi-truck is deployed with two HD LIDAR sensors, according to one or more embodiments. In the example sensor configuration shown, FIG. 6A illustrates a left-side view of a forward portion of an autonomous truck 400, and FIG. 6B illustrates a top-down view of the autonomous truck 400. In this sensor configuration, two HD LIDAR sensors are mounted on the top (e.g., on the roof) of the truck 400, or atop the sideview mirrors of the truck 400. In this configuration, the field of view for the front region 402 is formed by fusing or combining the sensor data from each of the HD LIDAR sensors mounted at positions 610 and 630. Additional sensors and sensor combinations of alternative types can be mounted to lower positions 620 and 640. For example, with respect to examples of FIG. 6A and FIG. 6B, the truck 400 may also be equipped with sensor assemblies which include LD LIDAR sensors (e.g., a VLP-16), one or more cameras, and one or more radars collocated at lower positions 620 and 640.

According to various implementations, the HD LIDAR sensors at positions 610 and 630 be mounted such that they extend from the sides of the roof or the side-mounted mirrors of the truck 400, and provide a field of view that encompasses the forward region 402, side cabin regions 404 and 406, side trailer regions 414 and 416, and/or extended rearward side regions 424 and 426. For example, the HD LIDAR sensors may be mounted such that each are vertically oriented, and a lower set of laser scanners have a negative elevation angle such that objects near the truck 400 may be detected. In variations, the HD LIDAR sensors mounted at locations 610 and 630 may be mounted to have an angular orientation such that the generated point cloud maps can encompass an entirety of or portions of the side regions 404, 406, 414, 424, and 426. In example embodiments, the vertical orientation or elevated position of the HD LIDAR sensors at locations 610 and 630 can cause gaps (e.g., half-conical gaps) in HD point cloud maps corresponding to the side regions 404, 406, 414, 424, and 426. Additional sensors may be included at positions 620 and 640 to fill these HD point cloud gaps. For example, an LD LIDAR sensor may be mounted or integrated with the truck 400 at locations 620 and 640.

Sensor combinations of collocated LD LIDAR sensors, cameras, and/or radar sensors can be included at lower positions 620 and 640. For example, each location 620 and 640 can include a sensor combination comprising at least one camera, at least one radar, and/or at least one LD LIDAR sensor. Each sensor in the sensor combination can encompass the same or similar field of view (e.g., encompassing regions 404, 414 and 424 for a right-side sensor combination, and regions 406, 416, and 426 for a left-side sensor combination). The control system 100 of the autonomous truck 400 can fuse the radar data, LIDAR data, and/or image data from each sensor combination to perform object detection, classification, and tracking operations. In one example, each lower location 620 and 640 can include a camera and LD LIDAR sensor combination mounted thereon. In variations, each lower location 620 and 640 can include a camera, LD LIDAR, and radar sensor combination.

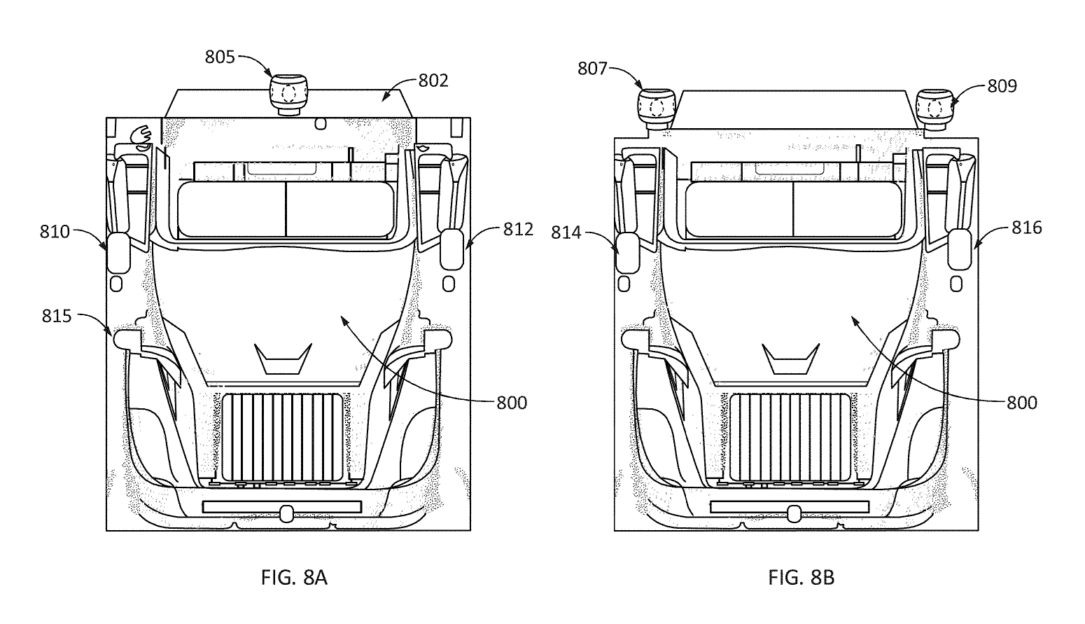

FIG. 7A and FIG. 7B illustrate a variation in which the truck 400 is deployed with three HD LIDAR sensors. In the example sensor configuration shown, FIG. 7A illustrates a left-side view of a forward portion of an autonomous truck 400, and FIG. 7B illustrates a top-down view of the autonomous truck 400. In FIG. 7A and FIG. 7B, HD LIDAR sensors are mounted to an exterior of the truck at a central roof location 710, a lower left-side location 720, and a lower right-side location 740. For example, two HD LIDAR sensors mounted at positions 720 and 740 may be mounted near or onto a side view mirror of the truck 400 to generate an HD point cloud map of regions 404, 406, 414, 416, 424, and 426. A third HD LIDAR sensor 710 is positioned at the central roof location 710 to provide an HD point cloud map of a forward operational direction of the truck 400, including region 402.

It is contemplated that the use of three HD LIDAR sensors at locations 710, 720, and 740 can reduce or eliminate the need for additional sensors (e.g., radar or cameras) due to the highly detailed point cloud map generated by HD LIDAR sensors. Positions 720 and 740 can comprise mount points corresponding to side view mirrors of the truck 400 that extend from the door, or forward side-view mirrors mounted to or near the hood of the truck 400. The locations 720 and 740 can extend further laterally than a full width of the cabin 410 and a full width of the trailer 420. In variations, the positions 720 and 740 can comprise mount points that extend the HD LIDAR sensors from the external wheel wells, sidestep, or side skirt of the truck 400. In further variations, the mount points for locations 720 and 740 can comprise pedestal mounts such that the HD LIDAR sensors remain vertically oriented, or alternatively, cause the HD LIDAR sensors to be angularly oriented.

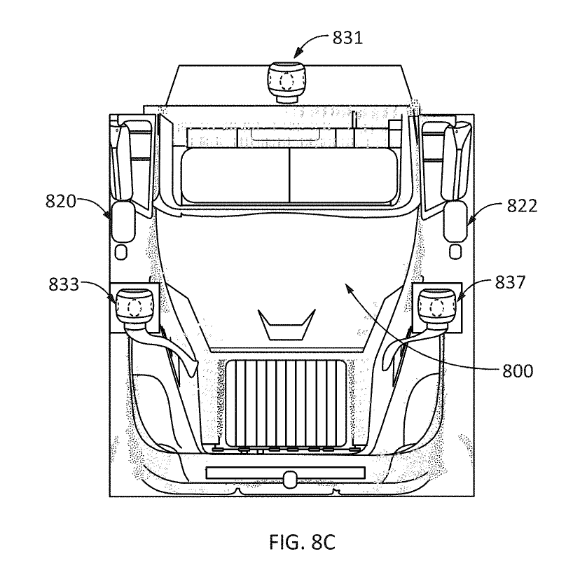

FIGS. 8A through 8C illustrate an autonomous truck 800 with sensor configurations as described herein. In the example sensor configurations of FIGS. 8A through 8C, HD LIDAR sensors are shown as standalone devices mounted to the truck 800. However, it is contemplated that additional sensors (e.g., a camera or radar) can be mounted to be collocated to each HD LIDAR sensor. For example, a pre-condition for each senor configuration can require that each field of view—corresponding to regions 402, 404, 406, 414, 416, 424, and 426 shown in FIG. 4—be targeted by both an active sensor (e.g., a LIDAR sensor or radar) and a passive sensor (e.g., a monocular or stereoscopic sensor).

Referring to FIG. 8A, the autonomous truck 800 can include a configuration corresponding to the sensor configuration shown and described with respect to FIGS. 5A and 5B, and include an HD LIDAR sensor 805 mounted to a central location of the roof 802 of the truck 800. This central HD LIDAR sensor 805 can generate a live, HD point cloud map of region 402—in a forward operational direction of the autonomous truck 800. However, the rooftop wind deflector of the truck 800 and or a forward surface of the trailer can block the rearward field of view of the HD LIDAR sensor 805. Accordingly, the sensor configuration shown in FIG. 8A includes a pair of sensor assemblies 810, 812 (e.g., corresponding to the sensor assembly 350 shown as described with respect to FIG. 3B) that can comprise fields of views that extend down the sides of the truck 800.

The sensor assemblies 810, 812 may be structured in a housing or package that mounts to each side of the truck 800. In some examples, the sensor assembly 810 mounts to a region that is under, or near the side rearview mirror of the truck 800 (e.g., mirrors mounted to the doors of the truck 800). In some aspects, the sensor assemblies 810, 812 can replace the side-mounted rearview mirrors of the truck 800. Accordingly, the overall dimensions of each sensor assembly 810, 812 may be such that it does not protrude beyond (or significantly beyond) the profile of current side mirrors of trucks 800. In variations, the sensor assemblies 810, 812 can be mounted to replace or be collocated with a forward rearview mirror 815 mounted to a hood of the truck 800. In any case, the sensor configuration of FIG. 8A can include a left sensor assembly 812 and a right sensor assembly 810, each mounted to a side component of the truck 800 and extending further laterally than the width of a coupled trailer.

As described herein, the sensor assemblies 810, 812 can be rearward facing, and can include a combination of an LD LIDAR sensor and a camera. In variations, the sensor assemblies 810, 812 can include a combination of an LD LIDAR sensor, a camera, and a radar sensor. The fields of view of the mounted sensor assemblies 810, 812 can substantially or fully encompass regions 404, 406, 414, 416, 424, and 426 shown in FIG. 4.

With reference to FIG. 8B, the sensor configuration can correspond to the configuration shown and described with respect to FIGS. 6A and 6B. In variations, other combinations of sensor types may be used with each of the sensor assemblies. The sensor configuration of FIG. 8B also comprises a pair of sensor assemblies 814, 816 mounted or integrated with side components of the truck 800 as described herein. The sensor configuration can further comprise a pair of HD LIDAR sensors 807, 809 mounted to the roof or on a boom that extends from the roof and can generate point cloud maps that encompass region 402. In certain configurations, the HD LIDAR sensors 807, 809 can be mounted on the roof towards the front of the cab of the truck 800, at a mid-way point of the roof, or near the rearwards corners of the roof of the cab. In each configuration, the HD LIDAR sensors 807, 809 can be mounted at or near the side edges of the roof. Furthermore, the HD LIDAR sensors 807, 809 can be mounted vertically or angled. In variations, the HD LIDAR sensors 807, 809 can be mounted to side components of the truck 800 (e.g., on an upper portion of the side view mirrors) such that the HD point cloud maps can include portions of the side regions.

With reference to FIG. 8C, the sensor configuration can correspond to the configuration shown and described with respect to FIGS. 7A and 7B. The sensor configuration shown in FIG. 8C includes three HD LIDAR sensors 831, 833, 837 positioned centrally on the roof of the truck 800, and one on each side of the truck 800. In some examples, the left HD LIDAR sensor 837 and the right HD LIDAR sensor 833 can be mounted to replace or to be collocated with forward side-view mirrors of the truck 800 (e.g., extending from the hood of the truck 800). In variations, the side-mounted HD LIDAR sensors 833, 837 can be mounted to replace or to be collocated with the side view mirrors extending from the doors of the truck 800.

The side-mounted HD LIDAR sensors 833, 837 can generate an HD point cloud that encompassed regions 404, 406, 414, 416, 424, and 426 shown in FIG. 4, and can further encompass region 402 in concert with the central, top-mounted HD LIDAR sensor 831. In some variations, one or more of the HD LIDAR sensors 805 shown in FIG. 8C may be omitted (e.g., the central top-mounted LIDAR sensor) or replaced with a sensor assembly. Alternatively, the sensor configuration shown in FIG. 8C may also include supplemental sensor assemblies 820, 822 mounted to side components of the truck 800 (e.g. on the side-view mirrors extending from the doors). As described herein, the sensor assemblies 820, 822 can be rearward facing to provide additional sensor coverage of side regions 404, 406, 414, 416, 424, and 426.

In some variations, the sensor assemblies 820, 822 and/or HD LIDAR sensors 831, 833, 837 may be mounted in additional or alternative configurations. For example, the sensor assemblies 820, 822 and/or HD LIDAR sensors 831, 833, 837 may be mounted to opposing rear columns of the cabin. In such configurations, a slight angular displacement may be used with respect to the trailer in order to enhance the field of view from the respective sensor assemblies 820, 822 and/or HD LIDAR sensors 831, 833, 837.

It is contemplated for examples described herein to extend to individual elements and concepts described herein, independently of other concepts, ideas or systems, as well as for examples to include combinations of elements recited anywhere in this application. Although examples are described in detail herein with reference to the accompanying drawings, it is to be understood that the concepts are not limited to those precise examples. As such, many modifications and variations will be apparent to practitioners skilled in this art. Accordingly, it is intended that the scope of the concepts be defined by the following claims and their equivalents. Furthermore, it is contemplated that a particular feature described either individually or as part of an example can be combined with other individually described features, or parts of other examples, even if the other features and examples make no mentioned of the particular feature. Thus, the absence of describing combinations should not preclude claiming rights to such combinations.

What is claimed is:

1. An autonomous semi-truck comprising:
a fifth wheel having a kingpin of a trailer coupled thereon;
a drive system operable to drive the autonomous semi-truck;
a configuration of sensors mounted to an exterior of the autonomous semi-truck, including (i) at least one high-definition (HD) LIDAR sensor having a first field of view that encompasses a region in front of the autonomous semi-truck, and (ii) a set of sensors having fields of view that encompass side regions extending laterally from each side of a trailer coupled to the autonomous semi-truck, the side regions extending rearward to include a length of the trailer; and
a control system comprising processing resources executing instructions that cause the control system to:
receive sensor data from the at least one HD LIDAR sensor and the set of sensors; and
autonomously operate the drive system based on the received sensor data.

2. The autonomous semi-truck of claim 1, wherein the set of sensors are included in a pair of sensor assemblies each mounted to an exterior side of the autonomous semi-truck.

3. The autonomous semi-truck of claim 2, wherein each of the pair of sensor assemblies is mounted to a lower portion of a side mirror extending from a door of the autonomous semi-truck.

4. The autonomous semi-truck of claim 2, wherein each of the pair of sensor assemblies is mounted to replace a side mirror extending from a door of the autonomous semi-truck.

5. The autonomous semi-truck of claim 2, wherein each of the pair of sensor assemblies is mounted to a side mirror extending from a hood of the autonomous semi-truck.

6. The autonomous semi-truck of claim 2, wherein each of the pair of sensor assemblies is mounted to replace a side mirror extending from a hood of the autonomous semi-truck.

7. The autonomous semi-truck of claim 2, wherein each of the pair of sensor assemblies includes a low definition (LD) LIDAR sensor.

8. The autonomous semi-truck of claim 2, wherein each of the pair of sensor assemblies includes at least one of a radar sensor or a camera.

9. The autonomous semi-truck of claim 2, wherein each of the pair of sensor assemblies includes an LD LIDAR sensor, a radar sensor, and a camera.

10. The autonomous semi-truck of claim 1, wherein the at least one HD LIDAR senor comprises an HD LIDAR sensor mounted centrally on a roof of the autonomous semi-truck.

11. The autonomous semi-truck of claim 1, wherein the at least one LIDAR sensor comprises two HD LIDAR sensors mounted on opposite sides of a roof of the autonomous semi-truck.

12. The autonomous semi-truck of claim 1, wherein the at least one LIDAR sensor comprises two HD LIDAR sensors mounted on opposite sides of the autonomous semi-truck and a third HD LIDAR sensor mounted centrally on a roof of the autonomous semi-truck.

13. The autonomous semi-truck of claim 12, wherein the two HD LIDAR sensors are mounted below the roof of the autonomous semi-truck.

14. An autonomous semi-truck comprising:
a fifth wheel having a kingpin of a trailer coupled thereon;
a drive system operable to drive the autonomous semi-truck;
a configuration of sensors mounted to an exterior of the autonomous semi-truck, including two high-definition (HD) LIDAR sensors mounted to an exterior of the autonomous semi-truck; and
a control system comprising processing resources executing instructions that cause the control system to:
receive sensor data from the two HD LIDAR sensors; and
autonomously operate the drive system based on the received sensor data.

15. The autonomous semi-truck of claim 14, wherein each of the two HD LIDAR sensors are mounted to a roof of the autonomous semi-truck.

16. The autonomous semi-truck of claim 14, wherein each of the two HD LIDAR sensors are mounted to replace a side mirror of the autonomous semi-truck.

17. The autonomous semi-truck of claim 14, wherein the configuration of sensors further includes a set of sensors mounted in a pair of sensor assemblies each mounted to an exterior side of the autonomous semi-truck.

18. The autonomous semi-truck of claim 17, wherein each of the pair of sensor assemblies comprises a low definition (LD) LIDAR sensor.

19. An autonomous semi-truck comprising:
a fifth wheel having a kingpin of a trailer coupled thereon;
a drive system operable to drive the autonomous semi-truck;
three high-definition (HD) LIDAR sensors mounted to an exterior of the autonomous semi-truck; and
a control system comprising processing resources executing instructions that cause the control system to:
receive sensor data from the two HD LIDAR sensors; and
autonomously operate the drive system based on the received sensor data.

20. The autonomous semi-truck of claim 19, wherein two of the three HD LIDAR sensors are mounted to opposing sides of the autonomous semi-truck, and a third HD LIDAR sensor of the three HD LIDAR sensors is mounted centrally on a roof of the autonomous semi-truck.
